(19) United States
(12) Patent Application Publication
(10) Pub. No.: US 2012/0143587 A1
(43) Pub. Date: Jun. 7, 2012

(54) ACCIDENT REDUCTION MEASURE SIMULATION DEVICE AND ACCIDENT REDUCTION MEASURE SIMULATION METHOD

(75) Inventor: Atsushi Minemura, Tokyo (JP)

(73) Assignee: PANASONIC CORPORATION, Osaka (JP)

(21) Appl. No.: 13/390,193

(22) PCT Filed: Jun. 13, 2011
(86) PCT No.: PCT/JP2011/003335

§ 371 Date: Feb. 13, 2012

(30) Foreign Application Priority Data
Jun. 16, 2010 (JP) 2010-137274

(51) Int. Cl. G06F 9/455

(52) U.S. Cl. 703/21

(57) ABSTRACT

Disclosed is a simulation apparatus for accident reduction measures which is capable of supporting the determination of measures to be applied. This apparatus (100) is a simulation apparatus for accident reduction measures in order to consider addition of an incidental facility on a road for the purpose of decreasing the number of accidents, and the apparatus includes: search section (160) that searches similar roads having a structure similar to that of a target road for consideration; and search result display section (190) that displays accident-related information on the similar roads searched by search section (160), so as to correspond to incidental facility statuses of the similar roads, wherein search result display section (190) displays the accident-related information to be comparable, relative to a plurality of different incidental facility statuses.

### TECHNICAL FIELD

The present invention relates to a simulation apparatus for accident reduction measures and a simulation method for accident reduction measures which aim to reduce the number of accidents on roads and are used to consider the addition of incidental facilities.

### BACKGROUND ART

The installation of incidental facilities, such as traffic lights, crosswalks, and pedestrian overpasses, at intersections on roads contributes to reduction of the number of accidents. However, the addition of incidental facilities involves costs. Therefore, according to the addition of incidental facilities (hereinafter, appropriately refer to “measures”), it is very important to verify the effect of reducing the numbers of accidents through simulation in advance, and determine highly cost-effective measures as measures to be applied.

In the verification of the effect of the measures through simulation, it is effective to refer to measure cases in the past in intersections having similar structures to that of the intersection subject to measurement.

Accordingly, for example, Patent Literature 1 describes a technique to classify intersections at various sites into schematic shape patterns, depending on the number of road segments coming together at the intersection, such as three-way or four-way intersections, and register the shape patterns. As a result, it is possible to easily search the intersections having similar structures to the intersection subject to measurement.

Furthermore, for example, Patent Literature 2 describes a technique to register the structures, incidental facility statuses and problems of intersections at various sites. As a result, it is possible to easily search measure cases of intersections having a similar structure and problem to those of the intersection subject to measurement.

### CITATION LIST

### Patent Literature

### PTL1

Japanese Patent Application Laid-Open No. 2007-279004

### PTL2

Japanese Patent Application Laid-Open No. HEI 9-251596

### SUMMARY OF INVENTION

### Technical Problem

However, in the techniques described in Patent Literatures 1 and 2, there is a problem that it requires time and procedures to determine measures to be applied. This is because, according to all the assumed or scheduled measures for implementation, a user needs to verify accident occurrence conditions and to compare the effects of the measures, on the basis of the measure cases, through the cut and try process.

It is therefore an object of the present invention is to provide a simulation apparatus and a simulation method for accident reduction measures which are capable of supporting the determination of measures to be applied.

### Solution to Problem

A simulation apparatus for accident reduction measures of the present invention is a simulation apparatus for accident reduction measures which is used to consider addition of an incidental facility for the purpose of decreasing the number of accidents on a road, the simulation apparatus for accident reduction measures includes: a search section that searches similar roads having a structure similar to the structure of a target road for consideration; and a display section that displays accident-related information on the similar roads searched by the search section, so as to correspond to incidental facility statuses of the similar roads, where the display section displays the accident-related information to be comparable, relative to a plurality of different incidental facility statuses.

A simulation method for accident reduction measures of the present invention is a simulation method for accident reduction measures which is used to consider addition of an incidental facility for the purpose of decreasing the numbers of accidents on a road, the simulation method for accident reduction measures includes the steps of: searching similar roads having a structure similar to a target road for consideration; and displaying accident-related information on the similar roads which are searched, so as to correspond to incidental facility statuses of the similar roads, where at the step of displaying the accident-related information, the accident-related information are displayed to be comparable, relative to a plurality of different incidental facility statuses.

### Advantageous Effects of Invention

The present invention makes it possible to display the accident-related information on similar roads to be able to contrast a plurality of different incidental facility statuses, so that it is possible to support the determination of measures to be applied.

### BRIEF DESCRIPTION OF DRAWINGS

FIG. 1 is a block diagram of an example of the structure of a simulation apparatus for accident reduction measures according to one embodiment of the present invention;

FIG. 2 is a drawing illustrating an example of a table representing an intersection structure according to the present embodiment;

FIG. 3 is a drawing illustrating an example of the definition of route numbers in the present embodiment;

FIG. 4 is a drawing illustrating an example of an accident database in the present embodiment;

FIG. 5 is a drawing illustrating an example of a similar structure table in the present embodiment;

FIG. 6 is a flowchart illustrating an example of all operations of a simulation apparatus for accident reduction measures according to the present embodiment;

FIG. 7 is a drawing illustrating an example of a target designation screen in the present embodiment;

FIG. 8 is a drawing illustrating an example of a search condition in the present embodiment;

FIG. 9 is a drawing for explaining the significance for the locations of routes in the present embodiment;

FIG. 10 is a drawing illustrating an example of a display screen of the search result in the present embodiment; and

FIG. 11 is a drawing illustrating another example of a display screen of the search result in the present embodiment.

### DESCRIPTION OF EMBODIMENTS

Hereinafter, an embodiment of the present invention will be described in detail with reference to the accompanying drawings. Note that the concept of roads includes intersections, and the following description will be given for an exemplary case of considering the addition of incidental facilities to the intersection of a road.

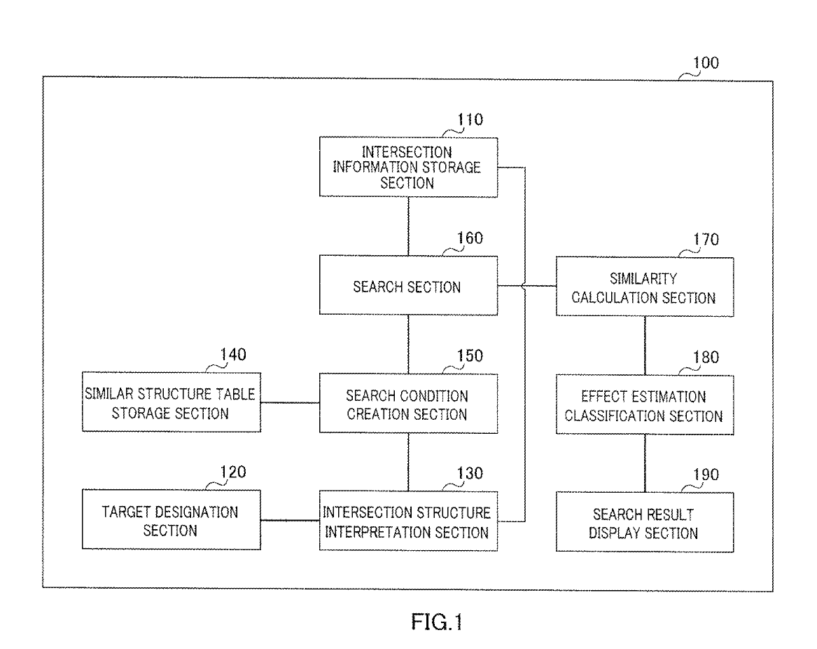

FIG. 1 is a block diagram of an exemplary structure of a simulation apparatus for accident reduction measures according to one embodiment of the present invention.

In FIG. 1, simulation apparatus for accident reduction measures 100 includes intersection information storage section 110, target designation section 120, intersection structure interpretation section 130, similar structure table storage section 140, search condition creation section 150, search section 160, similarity calculation section 170, effect estimation classification section 180, and search result display section 190.

Intersection information storage section 110 stores an intersection structure representation table and an accident database, beforehand. Note that intersection information storage section 110 may be a server connected to the Internet and the like, for example, a server provided by a public institution.

The intersection structure representation table is one in which the intersection structures and incidental facility statuses of individual intersections are described. The intersection structure is information indicating the shape of the intersection when one of the routes is used as a reference, and is defined for each route of the intersection. Hereinafter, assume that one intersection is handled differently depending on route which is a reference, as appropriate, and an intersection distinguished by the route is also called an “intersection.” Furthermore, the reference route of the intersection is called a “reference route.”

The accident database is a table in which accident-related information on individual intersections is described. The accident-related information is one regarding the number of occurred accidents per type of exemplary cases related to accidents (hereinafter, called “accident types”), such as accidents and incidents, for each route of an intersection (that is, for each intersection). The details of the intersection structure representation table and accident database will be described later.

Target designation section 120 receives, from a user, the designation of a target intersection for consideration (an intersection not classified by the routes) and the routes of the intersection, through a display unit such as a display apparatus and the like or an input unit such as a keyboard and the like (both are not shown). In addition, target designation section 120 receives the designation of a target accident type for reduction, such as “right-turn/straight accident,” from the user through the input unit. In response, target designation section 120 relates the accident type designated by the user (hereinafter called a “designated accident type”) to the intersection indicated by the designated intersection and the routes thereof (hereinafter called a “designated intersection”), and outputs this designated accident type to intersection structure interpretation section 130.

Intersection structure interpretation section 130 interprets the intersection structure of the designated intersection. Then, intersection structure interpretation section 130 relates the designated accident type and the interpreted intersection structure of the designated intersection to the designated intersection, and outputs the designated accident type and interpreted intersection structure to search condition creation section 150.

Similar structure table storage section 140 stores a similar structure table, beforehand. The similar structure table is a table in which routes for use in determining the similarity between the intersection structure of the designated intersection and those of other intersections are described for each accident type. The detail of the similar structure table will be described later.

Search condition creation section 150 refers to the similar structure table, and creates a search condition for searching similar intersections, on the basis of the intersection structure of the designated intersection and the designated accident type. The similar intersection is an intersection having an intersection structure similar to that of the designated intersection, and becomes a comparison targeted for considering the effect of the measures. In addition, search condition creation section 150 relates the designated accident type and the created search condition to the designated intersection, and outputs the designated accident type and the created search condition to search section 160.

Search section 160 searches similar intersections from the intersection structure representation table, on the basis of the search condition, and acquires the accident-related information on the searched similar intersections from the accident database. In addition, search section 160 acquires the accident-related information on the designated intersection from the accident database. Moreover, search section 160 relates, to the designated intersection and similar intersections, the search condition, and the intersection structures of intersections (shapes of intersections), incidental facility statuses (installed incidental facilities), and accident-related information (the number of occurred accidents for each accident type) which have been acquired from intersection information storage section 110, and outputs the result to similarity calculation section 170.

Similarity calculation section 170 calculates the structural similarity of each of the similar intersections. The structural similarity has a value indicating how much the intersection structure of each similar intersection is similar to that of the designated intersection. Then, similarity calculation section 170 relates the intersection structures, incidental facility statuses, accident-related information and structural similarities to the designated intersection and similar intersections, and outputs the result to effect estimation classification section 180.

Effect estimation classification section 180 calculates the facility addition degrees of the individual similar intersections. The facility addition degree is a value indicating the amount of the extra incidental facilities in comparison with the incidental facilities of the designated intersection. Then, effect estimation classification section 180 calculates the effect of decreasing the number of accidents for each facility addition degree. Specifically, effect estimation classification section 180 divides the similar intersections into some groups by using a threshold and the like for each of the combinations of an axis on which the facility addition degrees are classified and an axis on which the structural similarities are classified. Subsequently, effect estimation classification section 180 calculates the average of the number of occurred accidents each accident type (called merely an “accident average” hereinafter) having occurred per unit of time, such as within one year, for each group. Then, effect estimation classification section 180 relates the accident averages to the accident-related information on the designated intersection and the groups, and output the accident averages to search result display section 190.

Search result display section 190 displays the accident-related information so as to correspond to the incidental facility statuses and to be compared with one another, relative to a plurality of different incidental facility statuses. Specifically, search result display section 190 generates a display screen of the search result illustrating accident averages for each group, and displays this screen on the display unit. The detail of the display screen of the search result will be described later.

Simulation apparatus for accident reduction measures 100 is a computer including a CPU (Central Processing Unit), an interface for connecting to a network and the like, and a recording medium such as a RAM (Random Access Memory). Specifically, simulation apparatus for accident reduction measures 100 operates by the CPU executing a stored control program.

Simulation apparatus for accident reduction measures 100 including the above structure relates the accident-related information on the similar intersections to a plurality of different incidental facility statuses, and displays the pieces of information to be comparable. Consequently, simulation apparatus for accident reduction measures 100 can facilitate the understanding of the relationship between the measures for associated accidents and the effect thereof, thereby supporting the determination of measures to be applied.

Now, the detailed description will be given of various pieces of information stored in simulation apparatus for accident reduction measures 100.

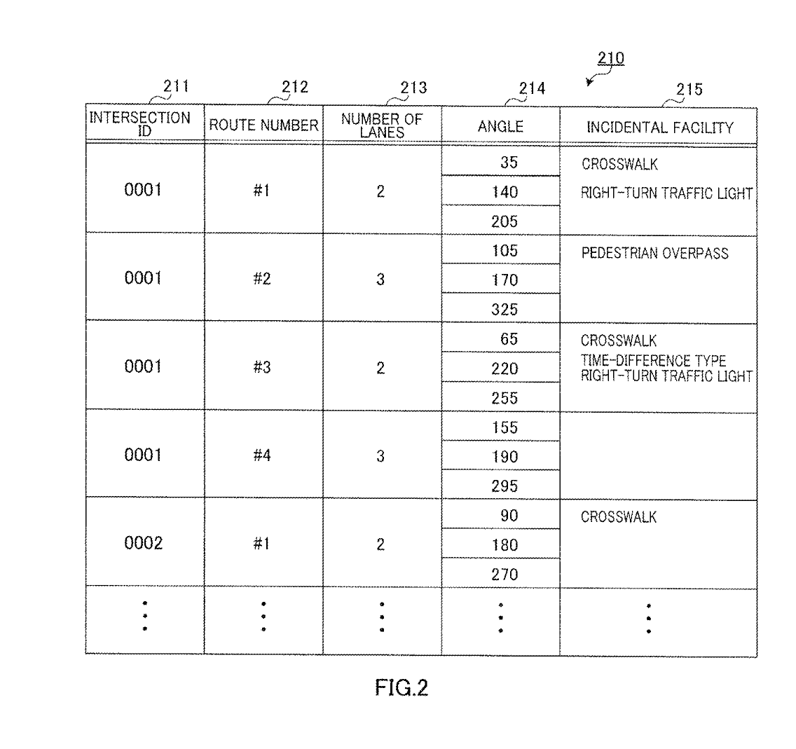

FIG. 2 is a drawing illustrating an example of the intersection structure representation table stored in intersection information storage section 110.

As shown in FIG. 2, intersection structure representation table 210 describes an intersection structure in relation to the combination of intersection ID 211 and route number 212. Intersection ID 211 is identity information on an intersection, independently of the routes. Route number 212 is identity information on routes. The intersection structure contains the number of lanes 213 and angle 214. Furthermore, intersection structure representation table 210 describes incidental facility 215, such as a crosswalk, right-turn traffic light and pedestrian overpass, in relation to the combination of intersection ID 211 and route number 212. The number of lanes 213 indicates the number of lanes on a reference route in relation to the combination of intersection ID 211 and route number 212. Angle 214 indicates a horizontal angle between a reference route and another route at the same intersection of the reference route. Incidental facility 215 indicates an incidental facility installed on a reference route, as an incidental facility status of the intersection.

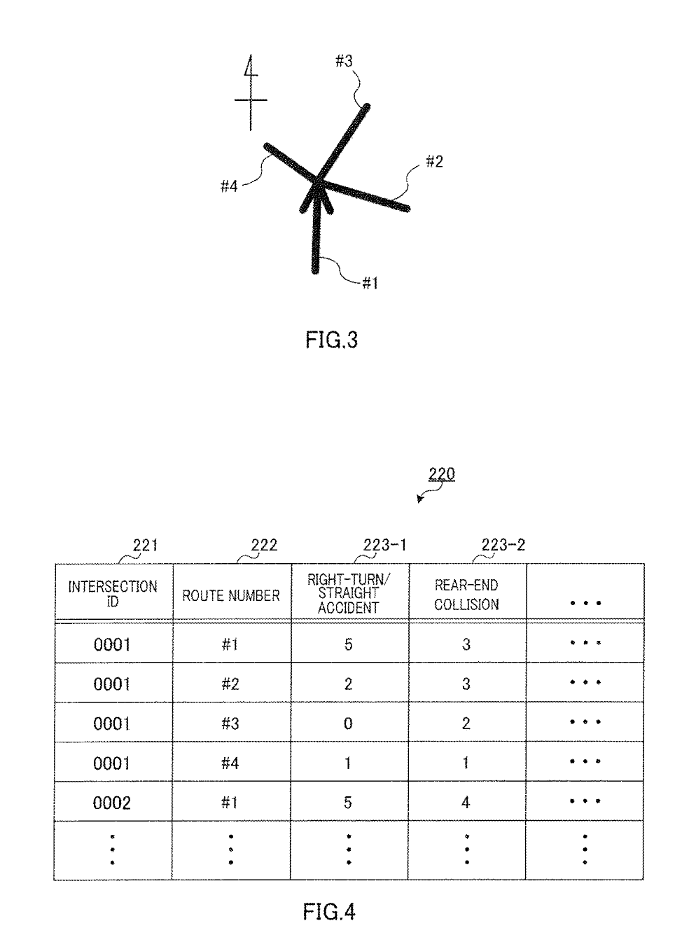

FIG. 3 is a drawing illustrating an example of the definition of route numbers in the present embodiment.

As shown in FIG. 3, for example, the route numbers of respective routes, each of which indicates the entry direction to the intersection, are defined as “#1, #2, #3, . . . ” in a counterclockwise order from the route located closest to the south side. Note that the upper side corresponds to the north side in FIG. 3. In this case, in intersection structure representation table 210, angle 214 described corresponding to the route number “#2” indicates, for example, respective counterclockwise angles of the routes “#3, #4 and #1” with respect to the route “#2.”

Simulation apparatus for accident reduction measures 100 can acquire the intersection structure and the incidental facility status of each intersection, on the basis of the definition of the route number shown in FIG. 3 and from the intersection structure representation table shown in FIG. 2.

FIG. 4 is a drawing illustrating an example of the accident database stored in intersection information storage section 110.

As shown in FIG. 4, accident database 220 describes the respective number of occurred accidents 223-1, 223-2, . . . for each accident type, in relation to the combination of intersection ID 221 and route number 222. The combination of intersection ID 221 and route number 222 corresponds to that of intersection ID 211 and route number 212 in intersection structure representation table 210 (see FIG. 2).

Simulation apparatus for accident reduction measures 100 can acquire the number of occurred accidents for each the accident type at each intersection from abovementioned accident database 220. Accident database 220 is created by collecting detection results from apparatuses that are installed at individual intersections for detecting the occurrence of accidents and incidents, for example.

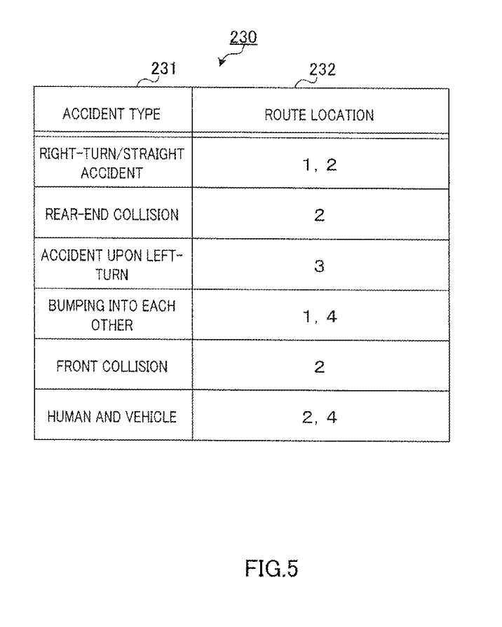

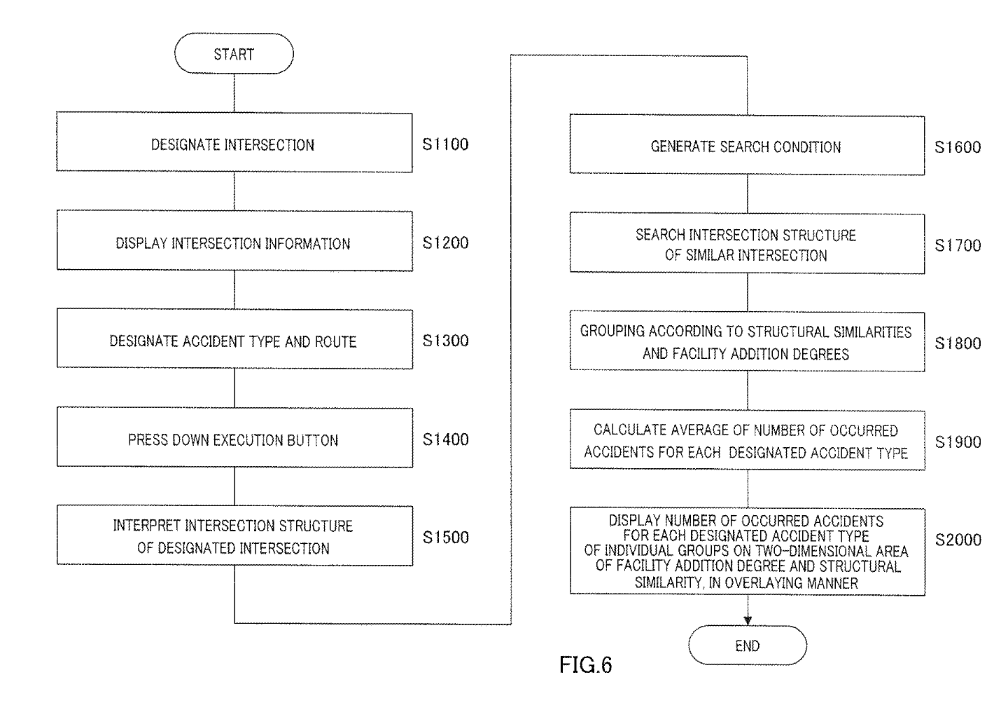

FIG. 5 is a drawing illustrating an example of the similar structure table stored in similar structure table storage section 140. This figure depicts an example of the similar structure table for a four-way intersection.

As shown in FIG. 5, similar structure table 230 describes route location 232 in relation to accident type 231. The route location is information indicating the relative location of a target route for similarity comparison, and is expressed by a number given, for example, by counting the each route counterclockwise from the reference route.

For example, route location 232 of “1, 2” is described in relation to accident type 231 of “right-turn/straight accident.” This description indicates that the right-turn/straight accidents (accidents caused by vehicles running straight and turning right) have occurred, depending on the angle of a route in a right-turn direction (first route 2 located counterclockwise with respect to route 1 being reference route on which the vehicle is running ahead) and the angle of a route in a straight direction (route 1 being the reference route on which the vehicle is running ahead), and suggests the necessity to search the incidental facility statuses and accident-related information of intersections where these angles of which are similar to each other.

Note that similar structure table storage section 140 also stores similar structure tables for intersections composed of three, five and other road segments, beforehand.

Simulation apparatus for accident reduction measures 100 can create conditions for searching appropriate intersections from similar structure table 230 described above, as similar intersections.

Hereinafter, a description will be given below of operations of simulation apparatus for accident reduction measures 100.

FIG. 6 is a flowchart illustrating an example of all operations of simulation apparatus for accident reduction measures 100.

First, at step S1100, target designation section 120 receives the designation of a target intersection for the consideration of the measures from a user. For example, target designation section 120 displays a road map, and receives the designation of the intersection through the operation of selecting a location on the road map.

Then, at step S1200, target designation section 120 acquires the intersection information on the designated intersection from, for example, intersection information storage section 110, and displays the acquired intersection information. Specifically, target designation section 120 provides the intersection information, as well as displays a target designation screen for receiving the designation of a target route for the consideration of the measures from a user. The intersection information contains the incidental facility statuses and accident-related information regarding the individual routes of the intersection.

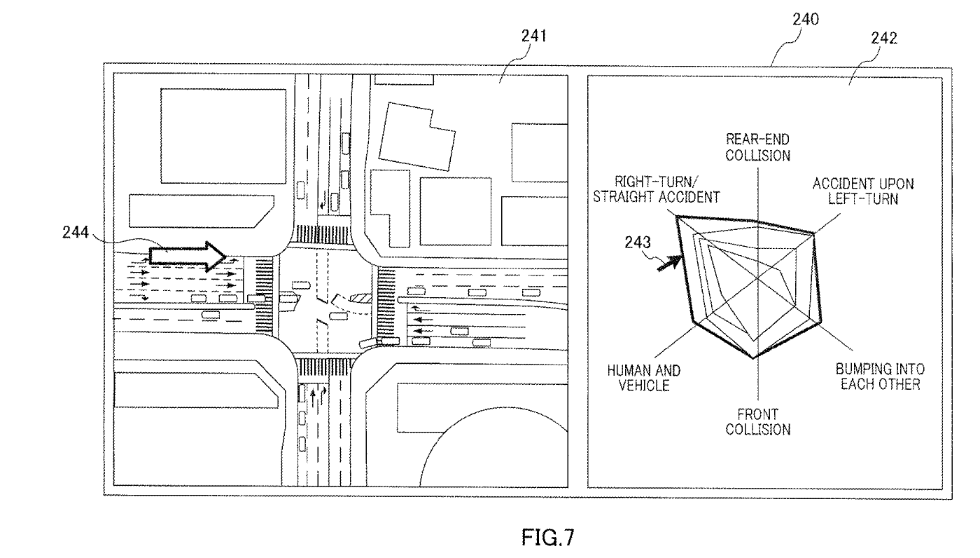

FIG. 7 is a drawing illustrating an example of the target designation screen.

As shown in FIG. 7, target designation screen 240 displays overhead image 241 revealing the intersection structure and incidental facility status of the intersection, and radar chart 242 illustrating the respective accident averages per the routes. Radar chart 242 is composed of four lines corresponding to respective four entry paths (routes) at a four-way intersection, and reveals which line corresponds to which route, according to types of lines, colors and the like. In addition, target designation screen 240 displays pointer 243 that are movable on radar chart 242 and enables operations. Furthermore, target designation screen 240 displays arrow mark 244 for pointing out the location of a route corresponding to that of pointer 243 on overhead image 241 in an overlaying manner.

At step S1300, target designation section 120 receives the designation of an accident type and a target route for accident reduction through target designation screen 240. A user views radar chart 242 of target designation section 120, and sets a position of pointer 243 onto, for example, a location illustrating the occurrence of many accidents (the outermost line of a right-turn/straight accident in FIG. 7). In response, target designation section 120 displays arrow mark 244 on the corresponding position of the route.

At step S1400, a decision operation is performed by the pressing down of an execution button (not shown) and the like, and in response, target designation section 120 determines that the displayed intersection, and the route and accident type corresponding to the position of pointer 243 have been designated.

At step S1500, intersection structure interpretation section 130 interprets the intersection structure of the designated intersection, for example, by referring to intersection information storage section 110.

At step S1600, search condition creation section 150 acquires route location 232 for the designated accident type from similar structure table 230 corresponding to the number of routes at the designated intersection. Following this, search condition creation section 150 creates a search condition, on the basis of acquired route location 232 and the intersection structure of the designated intersection. Specifically, for example, search condition creation section 150 sets a similarity range regarding the number of lanes, the angles of the routes, and the incidental facility status, on the basis of the number of lanes on the reference route and the respective angles of routes that correspond to the location of the acquired route, and the incidental facilities at the designated intersection. Then, search condition creation section 150 sets a condition of being included within the set similarity range, as the search condition. Note that the value of the similarity range of an incidental facility is set, for example, such that an incidental facility having a high frequency of measures is determined to be similar under the condition of a similar intersection structure and the same accident type.

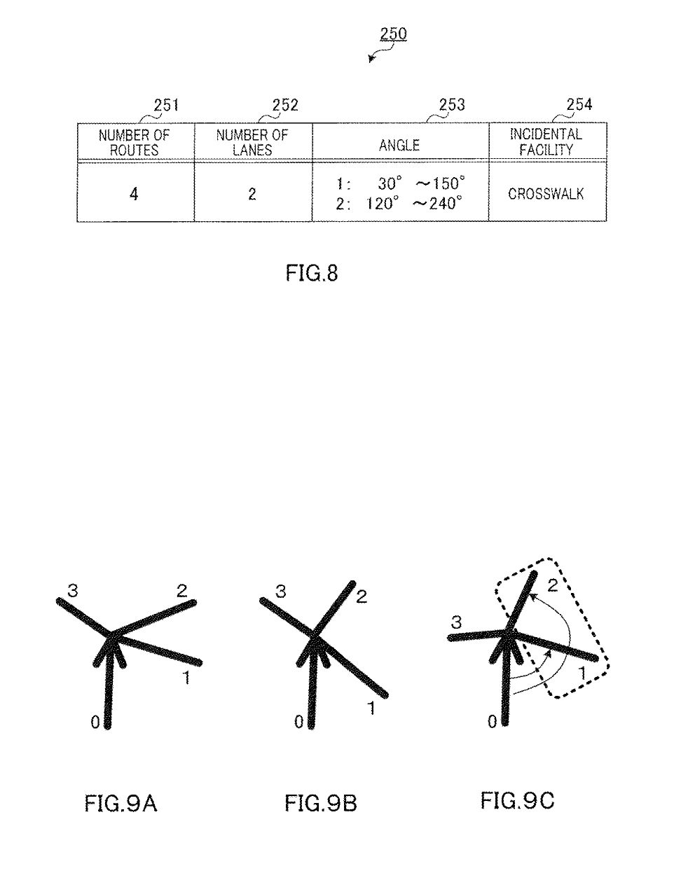

FIG. 8 is a drawing illustrating an example of the search condition.

As shown in FIG. 8, search condition 250 includes, for example, the number of routes 251, the number of lanes 252, angles of routes 253, and incidental facility 254. For example, the number of routes 251, the number of lanes 252, and incidental facility 254 simply employ the number of routes, the number of lanes, and the incidental facility, respectively, at the designated intersection. In addition, angle 253 for each route employs an angle range which is set by adding a predetermined margin to the angle of the route on the route location acquired from similar structure table 230 among the routes of the designated intersection.

Now, the signification that search condition 250 includes the locations of routes will be explained.

FIG. 9 is a drawing for explaining the signification of the locations of routes. FIG. 9A is a drawing illustrating the intersection structure of an intersection where only the angle of a route having a route location “2” of FIG. 9 (the route number #3 in FIG. 3) greatly differs, compared to the intersection structure shown in FIG. 3. FIG. 9B is a drawing illustrating the intersection structure of an intersection where only the angle of a route having a route location “1” of FIG. 9 (the route number #2 in FIG. 3) greatly differs, compared to the intersection structure shown in FIG. 3. FIG. 9C is a drawing illustrating the intersection structure of an intersection where only the angle of a route having a route location “3” of FIG. 9 (the route number #4 in FIG. 3) greatly differs, compared to the intersection structure shown in FIG. 3.

In this case, it is assumed that the route location corresponding to the designated accident type is “1, 2.” For example, considering the right-turn/straight accident occurring at a four-way intersection, let the route location which a first vehicle enters by turning right be 1, while let the route location where a second vehicle (opponent vehicle) enters by running straight in the intersection be 2. In this case, among the four routes, only first and second routes given by counting counterclockwise from the reference route are used to determine the similarity of the intersection structure, and are used for the search condition.

The criteria of selecting the location of a route as the search condition depends on whether or not this route location has a strong correlation with the target accident type for search. For example, the angle between the route of a route number #1 and the entry route influences the turning angle of the first vehicle when turning right, and influences the running speed when turning right, and the out-of-sight of the second vehicle and the like. Therefore, the correlation between the entry route and the route of the route number #1 is stronger than the correlation between the entry route and a route of a route number #3. Likewise, the angle between the route of route number #2 and an escape route (the same as the entry route) influences the speed at which the second vehicle enters the intersection, as well as the out-of-sight of the first vehicle and the like. Therefore, the correlation between the entry route and the route of the route number #2 is stronger than the correlation between the entry route and a route of a route number #3.

If the intersection structure of the designated intersection is the same as the intersection structure shown in FIG. 3, the angle between the route numbers #1 and #2 of FIG. 3 is similar to the angle between the route locations 0 and 1 of FIG. 9C. In addition, the angle between the route numbers #1 and #3 of FIG. 3 is similar to the angle between the route locations 0 and 2 of FIG. 9C. Accordingly, the intersection shown in FIG. 9C becomes a search target, while neither of the intersections shown in FIGS. 9A and 9B becomes a search target.

The accuracies of searching similar intersections and calculating structural similarities are critical at the stage of considering the measures for decreasing the number of accidents corresponding to each designated accident type. If the search condition is not narrowed down, a target for the consideration of the measures for accident reduction contains a lot of noise, and the abovementioned accuracies are degraded. For example, since the right-turn/straight accident is caused by vehicles turning right and running straight, the relationship between a reference route and a route for right-turn, that is, the angle therebetween is critical. Therefore, upon considering the measures for decreasing the number of right-turn/straight accidents, the priority order of the relationship between the reference route and a route for left turn and the like needs to be decreased for the search condition.

Hence, simulation apparatus for accident reduction measures 100 uses the similar structure table (see FIG. 5). With this table, simulation apparatus for accident reduction measures 100 performs the search and similarity determination on the basis of the structural factors narrowed down to the accident type to be decreased, in order to improve the abovementioned accuracies of the search and calculation.

At step S1700, search section 160 searches intersections matching the search condition from intersection structure representation table 210, as similar intersections. Subsequently, search section 160 acquires the accident-related information on the searched similar intersections from accident database 220.

At step S1800, similarity calculation section 170 calculates the structural similarities of the similar intersections. Subsequently, effect estimation classification section 180 calculates the facility addition degrees, and separates the similar intersections into some groups for each of the combinations of axes on which the facility addition degrees are divided and the structural similarities are divided. The structural similarity is calculated by using a value obtained by, for example, summing the differences of the angles of the target routes on each of all intersections and target roads for calculating similarities and normalizing the summed differences in accordance with the intersections and roads. Meanwhile, the facility addition degree is calculated by using a value obtained by, for example, summing the number of facilities to be added, the cost of area occupied by the facilities to be added (occupied spatial volume), the cost of time (the deadline of a construction, life period), the cost of facilities, the labor cost of installment, the sum of these costs, or a combination of the costs. Note that a method of calculating the structural similarity and facility addition degree is not limited to the present embodiment.

At step S1900, effect estimation classification section 180 calculates the accident average per time period for each group.

At a S2000, search result display section 190 displays the accident-related information, to be comparable, relative to a plurality of different incidental facility statuses. Specifically, search result display section 190 displays the respective accident averages of the groups on the display screen of the search result, while overlaying them on a two-dimensional area indicating a combination of the facility addition degree and the structural similarity.

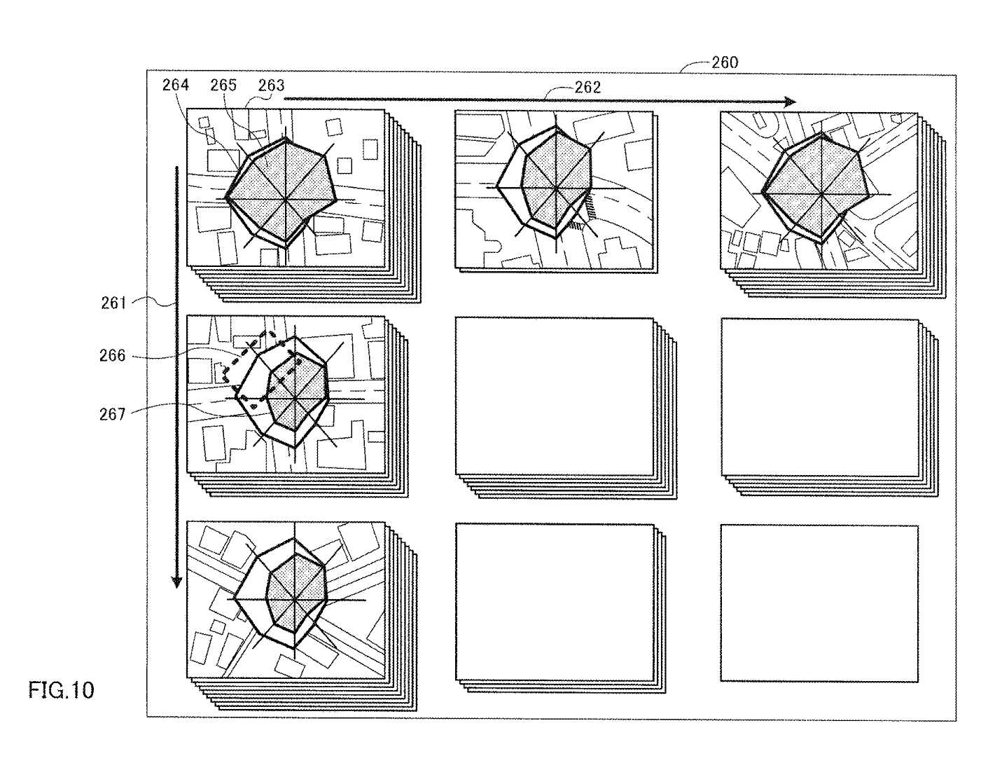

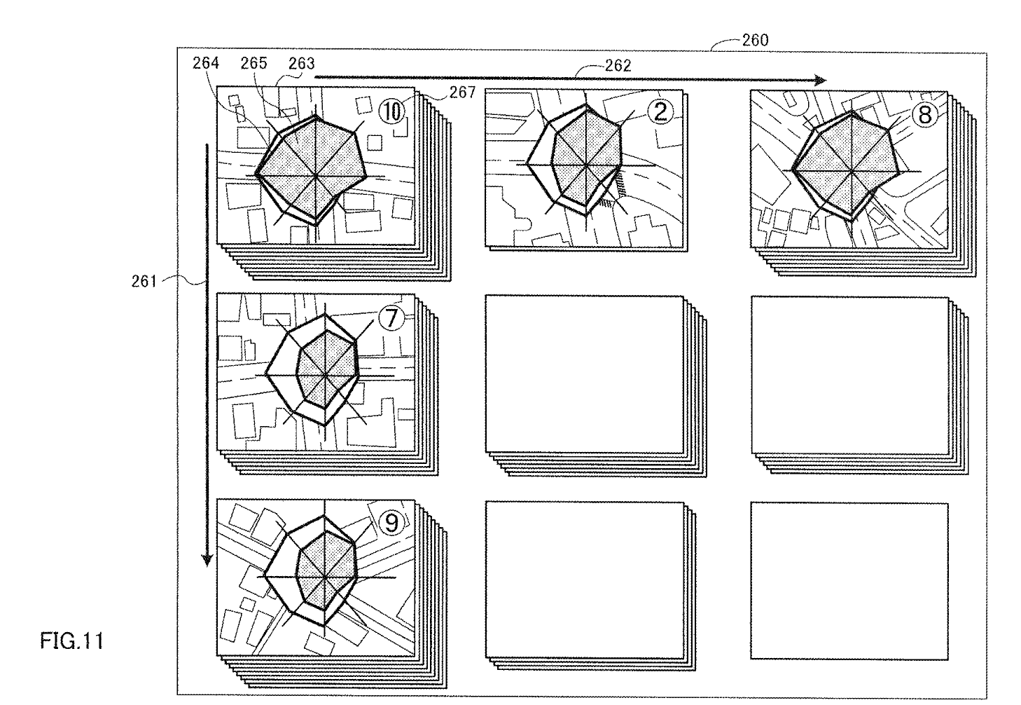

FIG. 10 is a drawing illustrating an example of a display screen of the search result.

As shown in FIG. 10, search-result display screen 260 displays the result of searching the similar intersections in a two-dimensional tile form. On this screen, vertical axis 261 corresponds to the facility addition degree, and this facility addition degree becomes higher toward the down. In other words, the added incidental facilities are increasing toward the down, compared to the designated intersection, so that the cost of adding incidental facilities is made higher. Meanwhile, horizontal axis 262 corresponds to the structural similarity, and the structural similarity becomes higher toward the left. In other words, toward the left, the intersection structures for exemplary accident case becomes more similar to intersections of the designated intersection, and therefore, it is considered that the accident occurrence factors due to the structures of intersections is decreasing. Thus, the difference of the accident occurrence conditions is more strongly and relatively influenced by the incidental facilities toward the left, and therefore, it is considered that the causal relationship between the incidental facility and the accident occurrence condition is made closer.

Each tile of FIG. 10 displays thereon overhead image 263 of a similar intersection and two radar charts 264 and 265 that show accident averages, similar to radar chart 242 of FIG. 7, in an overlaying manner. First radar chart 264 indicates the accident average of the designated intersection. Second radar chart 265 indicates the accident average of a similar intersection belonging to a corresponding group. Specifically, second radar chart 265 indicates the average accident occurrence condition for the intersection structure and incidental facilities of a similar intersection belonging to a corresponding group.

For example, the leftmost column indicates groups, each of which has substantially the same intersection structure and different incidental facilities, in comparison with those of the designated intersection. Moreover, for example, the uppermost row designates groups of similar intersections, each of which is equivalent to the designated intersection further provided with only a “right-turn lane.” The middle row designates groups of similar intersections, each of which is equivalent to the designated intersection further provided with a “right-turn lane” and a “right-turn traffic light.” The downmost row indicates groups of similar intersections, each of which is equivalent to the designated intersection further provided with a “right-turn lane,” a “right-turn traffic light” and a “pedestrian overpass.”

Now, it is assumed that the designated accident type is a “right-turn/straight accident” corresponding to the upper left part of radar charts 264 and 265. Upon comparing groups on the leftmost column, the difference in the accident average of the designated accident type between the uppermost group provided with only a “right-turn lane” and the designated intersection is minor, but the difference between the middle group provided with a “right-turn lane” and a “right-turn traffic light” and the designated intersection is significant, as surrounded by dotted line 266. This suggests that the addition of a “right-turn lane” and a “right-turn traffic light” to the designated intersection as incidental facilities makes it possible to produce the great effect on the right-turn/straight accident. In other words, the addition of a “right-turn lane” and a “right-turn traffic light” can be effective, concrete measures for decreasing the number of right-turn/straight accidents at the designated intersection. In addition, radar chart 267 displayed corresponding to dotted line 266 can be considered to be the simulation of the reduction effect which the measures are put into.

Furthermore, according to the accident average of the designated accident type, there is no difference between the group provided with a “right-turn lane” and a “right-turn traffic light” and the group further provided with a “pedestrian overpass.” This suggests that even the addition of not only a “right-turn lane” and a “right traffic,” but also a “pedestrian overpass” as incidental facilities does not contribute to the further improvement of the effect of decreasing the number of accidents, that is, does not produce the significant investment effect.

In other words, search-result display screen 260 can display thereon accident averages of groups having a plurality of different incidental facility statuses, to be comparable. With this search-result display screen 260, a user can easily understand the difference in the accident occurrence condition between the designated intersection and similar intersections, as well as how many incidental facilities need to be added in order to produce a significant effect. Therefore, a user can easily determine measures to be applied.

In addition, it is possible for a user to understand which of the facility addition degree and the structural similarity has a closer relationship with the accident occurrence condition, and to determine the investment effect of adding incidental facilities more correctly.

Note that since intersection information storage section 110 does not contain a sufficient number of pieces of intersection information and accident-related information, the information on groups corresponding to the left column may not be able to be displayed. Even in this case, a user can do a pseudo-simulation by referring to the radar charts on the middle and rightmost columns.

Furthermore, a user can understand at sight that the potential measures exerts another influence, or possesses a potential secondary harmful effect, for example, the addition of the incidental facility may cause the increase in rear-end collisions and the like, and be aware of the degree of the secondary harmful effect. Accordingly, simulation apparatus for accident reduction measures 100 can eliminate the troublesome procedure for repeating, many times, the steps of searching similar intersections under different conditions of incidental facilities to be added and the like, for the purpose of formulating measures for decreasing the number of accidents.

Note that search-result display screen 260 may display the respective reliabilities of statistical data on individual groups, for example, by illustrating the number of similar intersections 267 belonging to the corresponding groups, as shown in FIG. 11. FIG. 11 shows an example in which the number of similar intersections belonging to a corresponding group is displayed at the upper right corner of each tile. This enables a user to determine measures to be applied, in consideration of the reliability of accident average of each group that has been presented.

As described above, simulation apparatus for accident reduction measures 100 according to the present embodiment can display the accident-related information on similar intersections, to be comparable, relative to a plurality of different incidental facility statuses, thereby facilitating the understanding of the relationship between measures and the effect thereof. Consequently, simulation apparatus for accident reduction measures 100 can support the determination of measures to be applied. In more detail, simulation apparatus for accident reduction measures 100 enables the simple browsing of incidental facilities for having the best effect on accident reduction, including the comparison between an investment cost and the effect thereof, through a single search.

Moreover, simulation apparatus for accident reduction measures 100 searches appropriate similar intersections for each route and each accident type, thus eliminating the need for manually narrowing down information and achieving the simpler simulation of measures.

Note that in the present embodiment, the accident types used as search conditions of similar intersections correspond to the types of cases related to accidents, incidents and the like, but are not limited thereto. For example, simulation apparatus for accident reduction measures 100 may handle only accidents or incident cases having actually occurred, as accident types.

Note that in the present embodiment, the target is a similar intersection, but is not limit thereto. For example, simulation apparatus for accident reduction measures 100 may determine whether or not to install a curve mirror and the like at the curve of a single road as an incidental facility. In this case, the similar structure table may be a road ID, a route number (one type for an one-way road, two types for a both-way road), an angle of a curve (R value indicating how much a route is bent counterclockwise with respective to the traveling direction), an incidental facility (curve mirror, guard rail, road sign, lane line, center line, rumble strips, visual guidance facility, antiskid pavement and the like).

Alternatively, simulation apparatus for accident reduction measures 100 may define the weights of routes used to search similar intersections in similar structure table, instead of defining which route is used to search similar intersections.

Simulation apparatus for accident reduction measures 100 may search similar intersections and present the number of occurred accidents by using each lane of individual routes as a reference.

The method of designating an intersection and a route, and the method of designating a target accident type for reduction are not limited to the abovementioned examples. For example, simulation apparatus for accident reduction measures 100 may display an intersection, a route and an accident type through a pull down menu for selection, and receive the designation of the selection. Alternatively, simulation apparatus for accident reduction measures 100 may determine the accident type for the designated intersection that indicates an especially higher accident average compared with other intersections, and designate the determined accident type automatically.

The configuration of the display screen of the search result is not limited to the abovementioned example. For example, simulation apparatus for accident reduction measures 100 may display multiple structural similarities only for the accident-related information on a group having a high structural similarity. In addition, simulation apparatus for accident reduction measures 100 may display accident averages by using not the radar charts, but other drawings, tables or numerals. As the level of the number of occurred accidents for each accident type, simulation apparatus for accident reduction measures 100 may not use accident averages but other parameters as to the significance for considering the decrease in accidents, such as the cumulative number of occurred accidents for each accident type since a predetermined date.

Intersection information storage section 110 and similar structure table storage section 140 may be provided outside simulation apparatus for accident reduction measures 100. In this case, simulation apparatus for accident reduction measures 100 searches the information by communicating with intersection information storage section 110 and similar structure table storage section 140. Furthermore, search section 160 may be provided outside simulation apparatus for accident reduction measures 100. In this case, simulation apparatus for accident reduction measures 100 requests search section 160 to search the information by transmitting a search condition thereto, and receives the searched result from the search section.

The present invention is also applicable to various simulation apparatuses to be used for a purpose other than the decrease in accidents at intersections of roads.

The disclosure of Japanese Patent Application No. 2010-137274, filed on Jun. 16, 2010, including the specification, drawings and abstract is incorporated herein by reference in its entirety.

### INDUSTRIAL APPLICABILITY

The simulation apparatus and the simulation method for accident reduction measures according to the present invention are suitable for use in a simulation apparatus and a simulation method for accident reduction measures which are capable of supporting the determination of measures to be applied.

### REFERENCE SIGNS LIST

100 Simulation apparatus for accident reduction measures
110 Intersection information storage section
120 Target designation section
130 Intersection structure interpretation section
140 Similar structure table storage section
150 Search condition creation section
160 Search section
170 Similarity calculation section
180 Effect estimation classification section
190 Search result display section

1. A simulation apparatus for accident reduction measures which is used to consider addition of an incidental facility for the purpose of decreasing the number of accidents on a road, the simulation apparatus for accident reduction measures comprising:
a search section that searches similar roads having a structure similar to the structure of a target road for consideration; and
a display section that displays accident-related information on the similar roads searched by the search section, so as to correspond to incidental facility statuses of the similar roads,
wherein the display section displays the accident-related information to be comparable, relative to a plurality of different incidental facility statuses.

2. The simulation apparatus for accident reduction measures according to claim 1, wherein the road includes an intersection, and the structure includes a shape of the intersection when one of routes of the intersection is used as a reference, the simulation apparatus for accident reduction measures according to claim 1 further comprising:
a target designation section that designates the intersection and a route which are targeted for the consideration; and
a structure interpretation section that interprets the structure of the route designated by the target designation section, in the intersection designated by the target designation section,
wherein:
the search section searches similar intersections having a similar structure to the intersection interpreted by the structure interpretation section, and
the display section displays accident-related information on the similar intersections searched by the search section.

3. The simulation apparatus for accident reduction measures according to claim 2, wherein the display section displays the accident-related information on the similar intersections where the incidental facility is added, in comparison with the incidental facility of the route designated by the target designation section, in the intersection designated by the target designation section.

4. The simulation apparatus for accident reduction measures according to claim 3, wherein the display section displays levels of the numbers of occurred accidents per an accident type, as the accident-related information.

5. The simulation apparatus for accident reduction measures according to claim 4, wherein:
the target designation section further designates the accident type; and
the display section displays levels of the numbers of the occurred accidents belonging to the accident type designated by the target designation section, as the accident-related information.

6. The simulation apparatus for accident reduction measures according to claim 5, further comprising a similarity calculation section that classifies the similar intersections searched by the search section according to structural similarities,
wherein the display section displays the accident-related information so as to correspond to the structural similarities of the similar intersections, relative to a plurality of different similarities.

7. The simulation apparatus for accident reduction measures according to 6, wherein the display section displays the numbers of the occurred accidents belonging to the accident type for each of combinations of facility addition degrees of the incidental facility statuses and the structural similarities.

8. The simulation apparatus for accident reduction measures according to claim 7, wherein the display section disposes and displays the number of the occurred accidents belonging to the accident type, on a two-dimensional area, respective axes of which denote the facility addition degrees and the structural similarities.

9. A simulation method for accident reduction measures which is used to consider addition of an incidental facility for the purpose of decreasing the numbers of accidents on a road, the simulation method for accident reduction measures comprising the steps of:
searching similar roads having a structure similar to a target road for consideration; and
displaying accident-related information on the similar roads which are searched, so as to correspond to incidental facility statuses of the similar roads,
wherein at the step of displaying the accident-related information, the accident-related information are displayed to be comparable, relative to a plurality of different incidental facility statuses.
